(19) United States
(12) Patent Application Publication
(10) Pub. No.: US 2026/0065177 A1
(43) Pub. Date: Mar. 5, 2026

(54) MODEL PIPELINE GENERATION FOR TASK MANAGEMENT

(71) Applicant: Accenture Global Solutions Limited, Dublin (IE)

(72) Inventors: Sankar Narayan DAS, Barrackpore (IN); Kuntal Dey, Birbhum (IN); Kapil Singi, Bangalore (IN); Kaushik Amar Das, Guwahati (IN); Vikrant Kaulgud, Bangalore (IN); Vibhu Saujanya Sharma, Bangalore (IN); Samdyuti Suri, Faridabad, IN (US); Teresa Sheausan Tung, Los Angeles, CA (US); Adam Patten Burden, Singapore (SG)

(21) Appl. No.: 18/818,116

(22) Filed: Aug. 28, 2024

(51) Int. Cl. G06Q 10/0631

(52) U.S. Cl. CPC G06Q 10/06311

(57) ABSTRACT

Method, system, and computer-readable storage media for generating a foundation model pipeline including a set of foundation models for completion of a plurality of tasks. Each task of the plurality of tasks has a set of pre-conditions and a set of post-conditions. Based on the set of pre-conditions and the set of post-conditions, a set of possible plans for processing the plurality of tasks is generated. For each plan of the set of possible plans, the set of foundation models from a plurality of foundation models is identified for performing each task of the plurality of tasks according to the respective plan. Further, an efficiency score is estimated for each plan to perform the plurality of tasks according to the plan. Based on the estimated efficiency score of each plan, the set of foundation models is selected for the plurality of tasks.

### FIELD OF THE INVENTION

Various embodiments described herein relate generally to computer-implemented method, computer system, and computer program product for generating and orchestrating a model pipeline including multiple foundation models for completion of one or more tasks.

### BACKGROUND

Enterprises continuously seek to improve and gain efficiencies in their operations. To this end, enterprises employ software systems to support execution of tasks/operations. Enterprises integrate the software systems in the domain of an intelligent enterprise, which employs artificial intelligence (AI) that can include, for example, machine learning (ML) models. For example, AI can be used for data analytics and/or automating tasks in support of enterprise operations.

In the field of AI, Generative AI (GAI) has recently seen an explosion in popularity. The increasing power and popularity of GAI has seen enterprises seeking avenues to leverage GAI in improving enterprise operations. GAI includes foundation models that generate a variety of content including, but not limited to, text, images, audio, and video. Examples of the foundation models include Large Language Models (LLMs), which are a form of GAI that can be used to generate text for a variety of use cases.

### SUMMARY

Implementations of the present disclosure are generally directed to optimizing scheduling and execution of one or more tasks by creating a model pipeline, which includes a set of foundation models selected for the one or more tasks. The set of foundation models are selected in accordance with characteristics of each foundation model and preferences specified to be satisfied by each foundation model, while performing the one or more tasks.

In general, innovative aspects of the subject matter described in this specification provide a method for generating a foundation model pipeline including a set of foundation models for completion of a plurality of tasks. The method includes obtaining the plurality of tasks. Each task of the plurality of tasks has a set of pre-conditions and a set of post-conditions. Based on the set of pre-conditions and the set of post-conditions, the method includes generating a set of possible plans for processing the plurality of tasks. For each plan of the set of possible plans, the method includes identifying a set of foundation models from a plurality of foundation models for performing each task of the plurality of tasks according to the respective plan. The method includes estimating an efficiency score for each plan to perform the plurality of tasks according to the plan. The method includes selecting the set of foundation models for the plurality of tasks based on the estimated efficiency score of each plan.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 depicts an example environment that may be used to execute implementations of the present disclosure.

FIG. 2 depicts an example block diagram of a multi-model task orchestrator system including components to generate a foundation model pipeline including a set of foundation models for task management in accordance with implementations of the present disclosure.

FIG. 3 depicts an example block diagram of a task planner for generating plans for tasks in accordance with implementations of the present disclosure.

FIG. 4 depicts an example block diagram of a task scheduler for estimating efficiency scores of plans in accordance with implementations of the present disclosure.

FIG. 5 depicts an example block diagram of a task scheduler optimizer for generating a completion plan for execution of the tasks in accordance with implementations of the present disclosure.

FIG. 6 depicts an example process flow of orchestration and scheduling of the tasks in accordance with implementations of the present disclosure.

FIGS. 7A and 7B depict exemplary initial and updated plans for the tasks in accordance with implementations of the present disclosure.

FIG. 8 is a flow diagram that presents an example method for generating the foundation model pipeline for the tasks in accordance with implementations of the present disclosure.

FIG. 9 illustrates a computer system that may be used to implement the multi-model orchestrator system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

With the advent of Generative Artificial Intelligence (GAI) systems, enterprises are adopting the GAI systems to support execution of various tasks/processes. For example, a GAI system may support communications and interactions, and processes in software systems to support decision-making within the enterprises. Multiple applications within a corporate network environment may use and interact with foundation models/Large Language Models (LLMs) of the GAI systems to provide input and/or data for the execution of a wide variety of tasks, such as, human computer interactions (for example, question and answering), automating process execution, process planning, generating step-by-step procedures for the process execution, performing data analysis, and/or the like. Therefore, the foundation models have capability of processing Natural Language Processing (NLP) related tasks and processing unstructured data. Due to the capability of processing the unstructured data, the foundation models can be implemented in various domains and applications such as, software engineering, computational biology, medicine, marketing, and/or the like.

Use of the multiple foundation models is suitable within an enterprise ecosystem to perform multiple tasks. However, use of the foundation models in applications being supported by the enterprises is a non-trivial task, particularly in view of a diverse range of foundation models being available for consumption. More specifically, enterprises can require access to the multiple foundation models to meet needs of disparate tasks. Different foundation models have different strengths and weaknesses, which vary between contexts. This makes it difficult to optimize the use of foundation models, as optimization depends on a specific task. Consequently, for an application interacting with the multiple foundation models (for example, multi-model GAI paradigm) technical controls are needed.

Further, the enterprises require flexibility in applications without a significant coupling to the specific foundation models. For example, an ecosystem of an enterprise may evolve over time and, as such, tasks change over time. Additionally, there are multiple factors and considerations for determining an appropriate foundation model for a given task. In some examples, the foundation models are selected for the tasks based on a user-policy. For instance, in accordance with a user policy A, ‘n’ foundation models are selected to perform ‘n’ tasks. On the other hand, in accordance with another user policy B, ‘m’ foundation models (m<n) are selected to perform the ‘n’ tasks, which may optimize cost-performance trade-off. In some examples, the foundation models are selected for the tasks based on nature and sequence of the tasks. Therefore, selection of the foundation models for the tasks requires significant experimentation by each application and, currently, no common standards exist. As such, significant technical resources are wasted (e.g., over multiple experiments) in an effort to integrate the foundation models into the enterprise ecosystems. Further, sustainable operationalization of the foundation models at enterprise scale requires standardized governance, access, cost, service, and usage management to be in place.

In view of this, implementations of the present disclosure optimize performance of the multi-model GAI paradigm by generating a foundation model pipeline for one or more tasks. The foundation model pipeline includes a composition of a set of foundation models selected for the one or more tasks. The set of foundation models are selected in accordance with characteristics of foundation models and user preferences specified for the foundation models. Therefore, efficiency and quality of the one or more tasks may be improved, while satisfying user and task specific requirements.

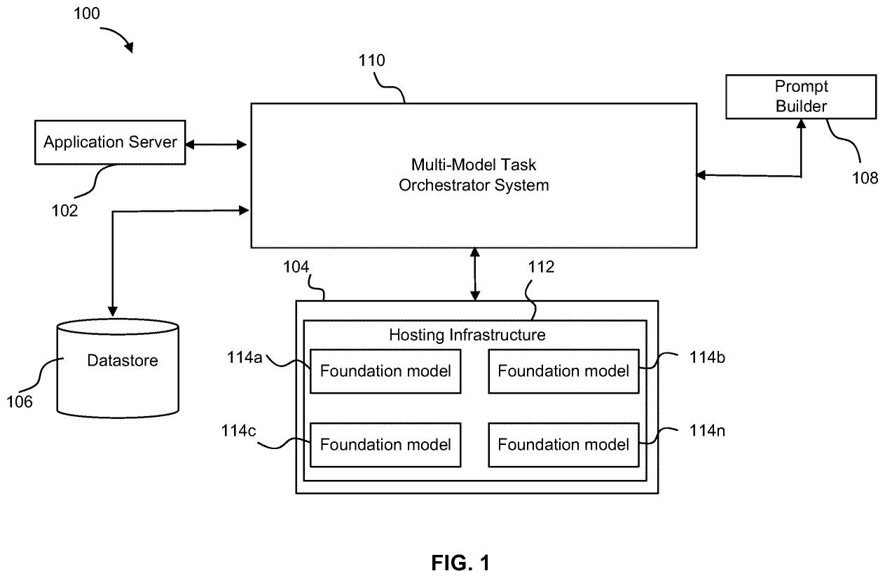

FIG. 1 depicts an example environment 100 that may be used to execute implementations of the present disclosure. In the example of FIG. 1, the example environment 100 includes one or more application servers 102, a Generative Artificial Intelligence (GAI) system 104, a datastore 106, a prompt builder 108, and a multi-model task orchestrator system 110.

Each of the application servers 102 executes one or more applications that consume the GAI system 104 being implemented by enterprise systems. In an example, an application may include a chatbot that provides responses generated by the GAI system 104 responsive to inputs/requests provided by users to the chatbot. The inputs/requests may indicate a domain and/or one or more tasks to be performed using the GAI system 104. Examples of the tasks may include text generation, text translation, question answering, code generation, data analysis, reasoning, and/or the like. The response(s) generated responsive to the input(s) may indicate results of the tasks being performed using the GAI system 104. In another example, the application may include any application that enables interactions with the GAI system 104 through the multi-model task orchestrator system 110 with different modalities. Examples of the modalities may include text, audio, image, video, and/or the like.

The GAI system 104 may be implemented by the enterprise systems for performing the tasks. The GAI system 104 includes a hosting infrastructure 112 to host one or more foundation models 114a-114n. It should be noted that the GAI system 104 may also include other components such as knowledge base, rules engine, and/or the like (not shown). The knowledge base includes domain knowledge associated with processes that may be executed using the foundation models 114a-114n.

The hosting infrastructure 112 represents technical infrastructure(s), where the foundation models 114a-114n are hosted. Examples of the hosting infrastructure 112 may include cloud computing platforms or the like. In some examples, the hosting infrastructure 112 may host the foundation models 114a-114n in different types of paradigms, which include, without limitation, model-as-a service (MaaS) models, specialized MaaS (SMaaS) models, self-deployed models, and/or the like.

In some examples, the foundation models 114a-114n may be provided by one or more third parties or the enterprise systems hosting the applications on the application server 102. A foundation model 114a-114n receives the requests/queries and provides the responses to the multi-model task orchestrator system 110 of the present disclosure. For example, the requests/queries may be received from the multi-model task orchestrator system 110 as prompts through an Application Programming Interface (API).

The foundation model 114a-114n may be described as a general-purpose GAI model like large deep learning neural network. The large deep learning neural network may be trained using a broad range of generalized, unlabeled training data and that may perform the tasks. In some examples, the applications may be built on top of the foundation models 114a-114n and the foundation models 114a-114n may be used to perform a range of functionality for the application.

The foundation models 114a-114n may include, for example, Large Language Models (LLMs), which are a form of GAI that may be used to generate text for a variety of use cases. In some examples, the LLMs may be integrated in digital assistants (for example, chatbots), replacing traditional rule-based systems to provide textual responses to an input. A LLM may be described as an advanced type of language model that is trained using deep learning techniques on massive amounts of text data. The text data is general and not specific to any particular domain. A LLM may described as an advanced type of language model that is trained using deep learning techniques on massive amounts of text data. The text data is general and not specific to any particular domain. The LLMs may generate human-like text and perform various Natural Language Processing (NLP) tasks (for example, translation, question-answering, and/or the like). In some examples, the LLM refers to models that use deep learning techniques and have a plurality of parameters, which may range from millions to billions. The LLMs may capture complex patterns in language and produce text that is often indistinguishable from that written by humans. The produced text may be processed through a deep learning architecture such as, recurrent neural network (RNN), a transformer model, and/or the like.

While implementations of the present disclosure are described in further detail herein with non-limiting reference to the LLMs as the example foundation models 114a-114n, it is contemplated that implementations of the present disclosure may be realized using any appropriate foundation models or Machine Learning (ML) models, or Artificial Intelligence (AI) models. Such models may generate the content/response based on any appropriate modality (for example, text, audio, image, video, and/or the like). In some examples, the response may correspond to the one or more of the tasks being represented by the request/prompt.

In some examples, the datastore 106 may act as a repository for various information related to the foundation models 114a-114n hosted in the hosting infrastructure. The information may include a number of foundation models 114a-114n available for the tasks, profiles of the foundation models 114a-114n, preferences to be satisfied by the foundation models 114a-114n while performing the tasks, input-patterns, and/or the like. The profiles of the foundation models 114a-114n (also be referred to as foundation model profiles) may indicate the tasks that can be performed using the foundation models 114a-114n and performance/performance quality of the foundation models 114a-114n for the tasks. The preferences (also be referred to as user profile) may indicate functional value requirements to be satisfied by the foundation models 114a-114n. Examples of the functional value requirements may include cost (for example, operational cost), performance, latency, and/or the like. The input-patterns may be patterns used for regulating/controlling behavior of the foundation models 114a-114n. The input-patterns may indicate a length of tokens in the prompts/input sequences to be inputted to the foundation models 114a-114n, a length of tokens in outputs/output sequences to be received from the foundation models 114a-114n, a type of each of the prompts to be inputted to the foundation models 114a-114n, a type of each of the outputs to be received from the foundation models 114a-114n, temperature, and/or the like.

In some examples, the prompt builder 108 enables building of the prompts for querying the foundation models 114a-114n. The prompts may be built using a set of prompt templates. For example, a library of prompt templates may be maintained, and each prompt template provides a pattern that is specific to the foundation model 114a-114n. In some examples, the prompt builder 108 enables the users to build and experiment with the prompts and compare the outputs/responses across the multiple foundation models 114a-114n. In such a way, the users may consider the quality of the outputs/responses and quantitatively determine cost and latency to use of the respective foundation models 114a-114n.

The multi-model task orchestrator system 110 may be implemented as an on-premises system that is operated by the enterprise or a third-party engaged in cross-platform interactions and data management. In some examples, the multi-model task orchestrator system 110 may be implemented as an off-premises system (for example, cloud or on-demand) that is operated by the enterprise or a third-party on behalf of the enterprise. In some examples, the multi-model task orchestrator system 110 may be implemented in a cloud environment. Further, the multi-model task orchestrator system 110 may be intended to represent various forms of servers including a web server, a proxy server, a network server, a server pool, and/or the like.

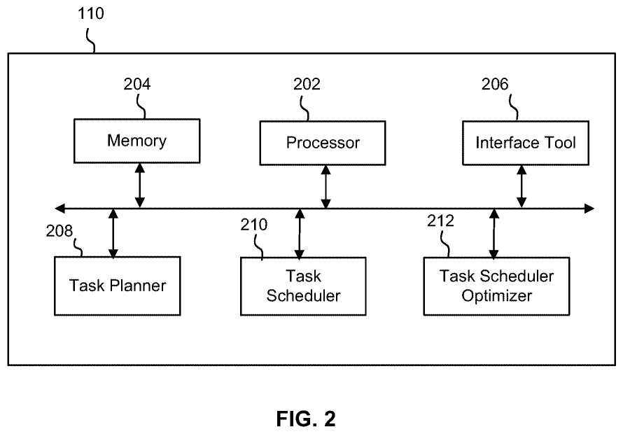

In accordance with implementations of the present disclosure, the multi-model task orchestrator system 110 receives the tasks, generates a foundation model pipeline for the tasks, and executes the tasks using the generated foundation model pipeline. The foundation model pipeline includes a composition of foundation models selected for the tasks. Various components of the multi-model task orchestrator system 110 is described in detail in conjunction with FIG. 2.

FIG. 2 depicts an example block diagram of the multi-model task orchestrator system 110 including components for generating the foundation model pipeline for task management in accordance with implementations of the present disclosure. The multi-model task orchestrator system 110 includes a processor 202, a memory 204, an interface tool 206, a task planner 208, a task scheduler 210, and a task scheduler optimizer 212.

The processor 202 may be connected to all the components 204-212 of the multi-model task orchestrator system 110. Further, the processor 202 may control all the components 204-212 of the multi-model task orchestrator system 110. In some examples, the processor 202 may include but not limited to, microprocessors, microcomputers, microcontrollers, digital signal processors, central processing units, state machines, logic circuits, and/or any devices that manipulate data or signals based on operational instructions. Among other capabilities, the processor may fetch and execute computer-readable instructions in the memory (also referred to be as computer-readable medium) 204. The memory 204 may be non-transitory or non-volatile medium, such as a magnetic disk or solid-state non-volatile memory or volatile medium such as Random Access Memory (RAM). The instructions or modules stored in the memory 204 may include machine-readable instructions executed by the processor 202 to perform the methods and functions of the multi-model task orchestrator system 110.

The interface tool 206 may represent one or more front-end components/interfaces of the application that may be executed on the application server 102 to enable receipt of the request and providing the response(s) to the request. In some examples, the request may include the prompt and may be received through various modalities including, but not limited to, a question input to a chat bot, a request provided through a Graphical User Interface (GUI), an email, and/or the like.

In accordance with implementations of the present disclosure, the request includes the one or more tasks to be performed. Examples of the tasks may include text generation, text translation, question answering, code generation, data analysis, reasoning, and/or the like.

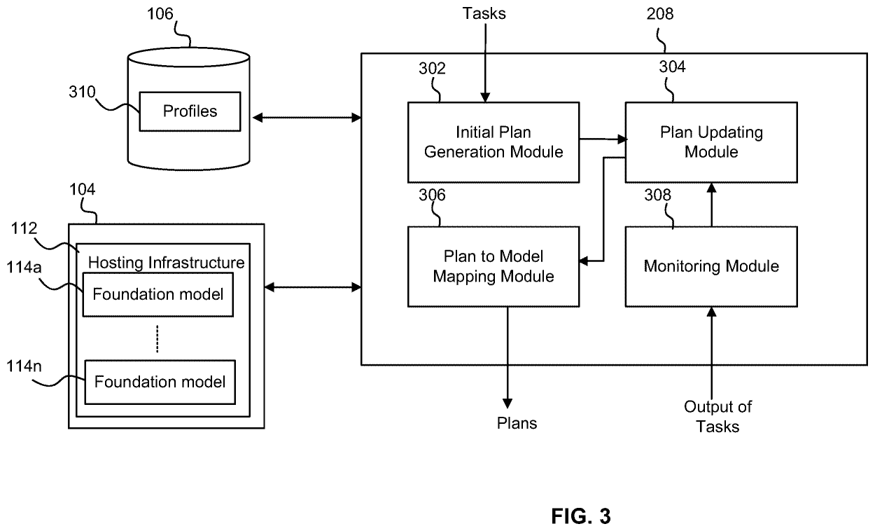

Once the tasks are obtained from the request, the task planner 208 generates a set of possible plans for the tasks. A plan may indicate orders/schedules of the tasks. The task planner 208 generates the plans based on pre-conditions and post-conditions of the tasks. The pre-conditions and post-conditions may describe conditions to be satisfied before and after completion of the tasks. Also, the post-conditions of one task may act as pre-conditions/input for a subsequent task. Upon generating the plans, the task planner 208 identifies a set of foundation models from the foundation models 114a-114n for the tasks present in each plan. The task planner 208 may identify the set of foundation models based on the preferences and the profiles of the foundation models 114a-114n. Thereby, the task planner 208 profiles the tasks by generating the plans and maps the plans to the foundation models. The task planner 208 is described in detail in conjunction with FIG. 3.

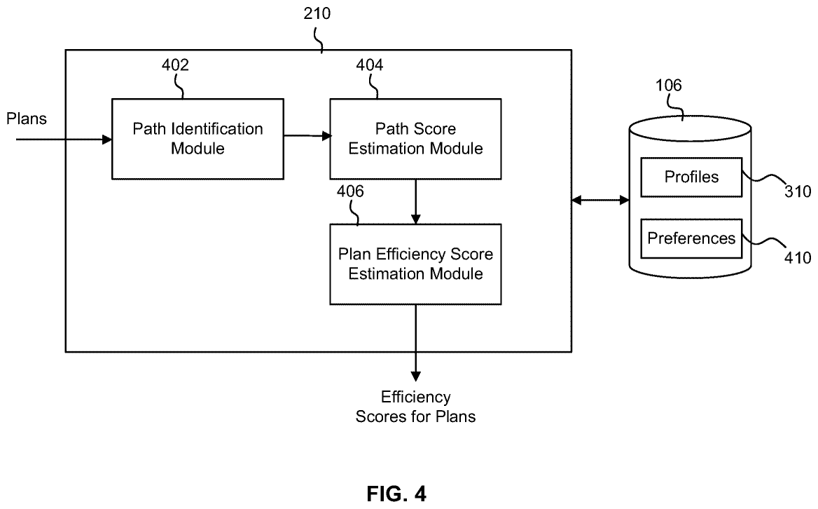

After generating the plans and mapping the plans to the foundation models, the task scheduler 210 estimates efficiency scores of the plans. The task scheduler 210 estimates the efficiency scores of the plans based on the number of foundation models 114a-114n available for the tasks, the preferences for the foundation models 114a-114n, and the profiles of the foundation models 114a-114n. The efficiency score of the plan may indicate efficiency of the plan to execute the tasks while satisfying the preferences. For example, if the preference includes cost, the efficiency score of the plan may indicate whether the respective plan is cost optimized plan or not. If the efficiency score is high, the plan may be executed with less cost and vice-versa. The task scheduler 210 is described in detail in conjunction with FIG. 4.

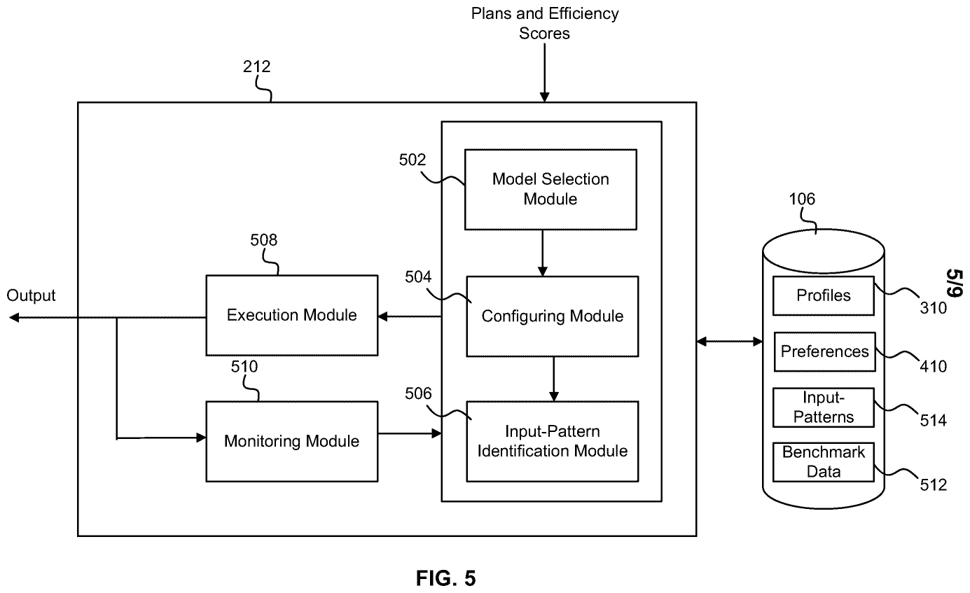

Based on the estimated efficiency scores of the plans, the task scheduler optimizer 212 generates a completion plan for execution of the tasks. The task scheduler optimizer 212 selects a plan from the plans by comparing the efficiency scores of the plans between each other. Upon selecting the plan, the task scheduler optimizer 212 selects one or more foundation models from the set of foundation models identified for the selected plan for execution of the tasks. The task scheduler optimizer 212 further configures the selected foundation models and identifies the input-patterns for controlling of the selected foundation models while executing the tasks. Therefore, the completion plan may indicate the plan for execution of the tasks, the foundation models for the tasks, configuration of the foundation models and the input patterns for the foundation models. Executing the tasks using such a completion plan optimizes quality of output of the tasks, while efficiently using the foundation models. The task scheduler optimizer 212 is described in detail in conjunction with FIG. 5.

Consider an example scenario, wherein the task planner 208 receives tasks 1 and 2. The task planner 208 identifies the tasks 1 and 2 as task 1: generate a set of test cases to check requirements and task 2: generate python-code from the requirements and the generated test cases, which are generated during the task 1. Upon identifying the tasks, the task planner 208 generates the plans for the tasks 1 and 2. Further, the task planner 208 maps the plans to the foundation models, for example, foundation models A and B. The plans may be mapped to the foundation models A and B, based on the profiles of the foundation models A and B and pre-conditions and post-conditions of the tasks 1 and 2. The profiles of the foundation models A and B indicate the tasks for which the foundation models A and B can be used, and performance and cost of the foundation models A and B for the tasks 1 and 2, as depicted in an example table 1 below:

TABLE 1
Profiles of foundation models A and B

| Foundation | | | |
|---|---|---|---|
| Model | Task Description | Performance | Cost |
| Model A | Test case generation | 0.8 | $0.03/1K Tokens |
| | from requirement | | |
| Model B | Test case generation | 0.8 | $0.04/1K Tokens |
| | from requirement | | |
| Model A | Python Code generation | 0.7 | $0.03/1K Tokens |
| Model B | Python Code generation | 0.6 | $0.04/1K Tokens |

In an example herein, the task planner 208 may select the foundation model A for the tasks 1 and 2, as the performance and cost of the foundation model A dominates the performance and cost of the foundation model B for the tasks 1 and 2. Upon selecting the foundation model A for the tasks 1 and 2, the task planner 208 generates the plan for execution of the tasks 1 and 2 using the foundation model A. For example, the plan may include task 1: generate test cases from the given requirement, foundation model A: Precondition: NULL, Postcondition: NULL, and task 2: generate python-code from the given requirement and the output of task 1, foundation model A, Precondition: NULL, Postcondition: NULL. Similarly, the task planner 208 may generate the other possible plans.

Once all the possible plans are generated, the task scheduler 210 estimates the efficiency scores of the plans. Based on the efficiency scores of the plans, the task scheduler optimizer 212 generates the completion plan for execution of the tasks 1 and 2. The task scheduler optimizer 212 selects the plan based on the associated efficiency score and selects the foundation model identified for the plan for execution of the tasks 1 and 2. Further, the completion plan may be generated by updating the pre-conditions and the post-conditions of each of the tasks 1 and 2. For example, the pre-conditions and the post-conditions may be updated as:
task 1: i) pre-condition: foundation model A configuration: max_new_tokens: 200; and ii) post-condition: a maximum length of description of test cases=100 tokens
task 2: i) pre-condition: foundation model A configuration: max_new_tokens: 200 and ii) post-condition: NULL.

The task scheduler optimizer 212 executes the tasks 1 and 2 according to the generated completion plan.

FIG. 3 depicts an example block diagram of the task planner 208 including components for generating the plans for the tasks in accordance with implementations of the present disclosure. The task planner 208 obtains the tasks from the interface tool 206 and generates the plans for the tasks. Each plan may indicate execution orders/schedules of the tasks, thereby providing a suitable plan space for scheduling the tasks and accordingly achieving completion of the tasks.

As depicted in FIG. 3, the task planner 208 includes an initial plan generation module 302, a plan updating module 304, a plan to model mapping module 306, and a monitoring module 308.

The initial plan generation module 302 obtains the tasks for processing from the interface tool 206. In some examples, the initial plan generation module 302 may also obtain task descriptions for the tasks. The task descriptions may provide context for execution of the tasks. Upon obtaining the tasks and/or the task descriptions, the initial plan generation module 302 generates an initial plan. For generating the initial plan, the initial plan generation module 302 may identify the pre-conditions and post-conditions of the tasks. In some examples, the initial plan generation module 302 may identify the pre-conditions and post-conditions of the tasks based on the task description. By matching the post-conditions of one task (for example, a first task) to the pre-conditions of other task (for example, a second task), the initial plan generation module 302 may generate the initial plan.

In some examples, the initial plan may be represented in a form of graph having an origin node and an end node. The origin node may represent the pre-conditions of the tasks to be satisfied. The end node may represent the post-conditions of the tasks to be satisfied. Further, there may exist a set of paths. Each path may be originated from the origin node and merged with the end node. Each path may have a vertex representing one of the tasks. The vertex of a path may be connected to a vertex of another path, when an output and the post-conditions of the task represented by the path satisfy the pre-conditions of the task represented by another path. As a non-limiting example, consider that the received tasks include a task 1 and a task 2. In such a scenario, an initial plan generated for the tasks 1 and 2 may include a directed edge between two vertices of the paths representing tasks 1 and 2, if an output and post conditions of the task 1 satisfy preconditions of the tasks 2.

Once the initial plan is generated, the plan updating module 304 generates the set of possible plans for the tasks by searching and combining different orderings/schedules of the tasks, while the generated plans satisfy the pre-conditions and the post-conditions of the tasks.

For each of the plans generated for the tasks, the plan to model mapping module 306 identifies the set of foundation models from the foundation models 114a-114n. The set of foundation models includes foundation models that provide the best performance among the foundation models 114a-114n for the tasks while satisfying the pre-conditions and the post-conditions of the tasks.

The plan to model mapping module 306 may identify the set of foundation models for each plan, based evaluation of the pre-conditions and post-conditions of the tasks included in the plan, and the profiles 310 of the foundation models 114a-114n. The profiles 310 of the foundation models 114a-114n may be accessed from the datastore 106. The profiles of the foundation models 114a-114n may indicate the tasks that can be performed using the foundation models 114a-114n and the performance quality of the foundation models 114a-114n for the tasks.

In some examples, for identifying the set of foundation models for each plan, the plan to model mapping module 306 may perform the evaluation of the pre-conditions and post-conditions of the tasks included in the plan and the profiles 310 of the foundation models 114a-114n using a multi-criteria decision analysis method like “The Technique for Order of Preference by Similarity to Ideal Solution” (TOPSIS) which is known in the art and not further described herein.

The plan to model mapping module 306 provides the set of possible plans generated for the tasks and the set of foundation models identified for each plan to the task scheduler 210 for estimating the efficiency scores of the plans.

In accordance with implementations of the present disclosure, the task planner 208 may dynamically regenerate the plans for the tasks during execution of the tasks. For dynamically regenerating the plans, the monitoring module 308 monitors an output of each of the tasks performed using the selected foundation model and a quality of the output. If the quality of the output obtained from execution of any of the tasks is low, the plan updating module 304 regenerates the plans to execute/complete the remaining tasks. As the overhead of plan generation is low, overhead of dynamic plan scheduling may also be low. Consider an example scenario, wherein a plan A is selected for execution of three tasks 1, 2, and 3 using foundation models A, B, and C. In such a scenario, the monitoring module 308 monitors that an output obtained from the execution of the task 1 using the foundation model A is low. Based on the monitoring, the plan updating module 304 regenerates the possible plans for execution of the remaining tasks 2 and 3.

FIG. 4 depicts an example block diagram of the task scheduler 210 including components for estimating the efficiency scores of the plans in accordance with implementations of the present disclosure. The task scheduler 210 receives the plans generated for the tasks from the task planner 208 and estimates the efficiency scores of the plans.

As depicted in FIG. 4, the task scheduler 210 includes a path identification module 402, a path score estimation module 404, and a plan efficiency score estimation module 406.

The path identification module 402 identifies all the paths of each plan based on a task schedule ‘S’ of the plan ‘P’. For example, the task schedule ‘S’ may indicate orders/schedules of the tasks in the plan ‘P’ and the foundation models identified for each task of the plan. For example, the task schedule ‘S’ may indicate a sequential list of task and foundation model pairs such as <task 1, foundation model_1>, <task_2, foundation model_2> . . . <task_m, foundation model_m>.

Upon obtaining the task schedule ‘S’ of the plan ‘P’, the path score estimation module 404 estimates efficiency scores of all the paths of each plan. The path score estimation module 404 may estimate the efficiency score ‘e_S’ of a path of the plan ‘P’ based on a utility factor and an incentive factor. The utility factor may indicate utility of performing the task ‘i’ using the identified foundation model ‘foundation model_i’ (for example, ‘U (task_i, foundation model_i)). The utility factor may be estimated based on the preferences 410 of the foundation models in the plan, and the profiles 310 of the foundation models in the plan. The preferences 410 and the profiles 310 may be accessed from the datastore 106. The incentive factor ‘∂’ may provide an incentive indicating use of the foundation models in the plan. For example, the incentive factor may indicate how to use the identified foundation models in the plan, based on the performance quality of the respective foundation models. The incentive factor ‘∂’ may vary between 0 and 1 (for example, 0<∂<1). In some examples, the incentive factor ‘∂’ may be pre-defined and dynamically varied based on the performance quality of the foundation models.

For example, based on the utility factor and the incentive factor, the path score estimation module 404 may estimate the efficiency score ‘e_S’ of the path of the plan ‘P’ as:

$$e\_S = e\_S + {\partial }^{( i - 1 )} * U ( task\_i , foundation model\_i )$$

After estimating the efficiency score ‘e_S’ of the path of the plan ‘P’, the path score estimation module 404 updates the efficiency score ‘e_S’ of the path as:

$$e\_S = e\_S / \vert S \vert$$

Based on the updated efficiency score ‘e_S’ of the path of the plan, the plan efficiency score estimation module 406 estimates the efficiency score ‘e_P’ of the plan ‘P’. For example, the efficiency score ‘e_P’ may be estimated as:

$$e\_P = e\_P + e\_S ,$$

wherein initially ‘e_P’ may be set to ‘0’.

The plan efficiency score estimation module 406 updates the efficiency score ‘e_P’ of the path upon estimating the efficiency score of each path of the plan. Similarly, the plan efficiency score estimation module 406 estimates the efficiency scores of all the plans. The plan efficiency score estimation module 406 may provide the efficiency scores of all the plans to the task scheduler optimizer 212 for generating the completion plan for execution of the tasks.

FIG. 5 depicts an example block diagram of the task scheduler optimizer 212 including components for generating the completion plan for execution of the tasks in accordance with implementations of the present disclosure. The task scheduler optimizer 212 generates the efficient completion plan for execution of the tasks using one or more of the appropriate foundation models 114a-114n. The completion plan may indicate the plan/order of execution of the tasks, the foundation models to be used for execution of the tasks, configuration of the foundation models, the input-patterns for regulating behavior of the foundation models, and/or the like.

As depicted in FIG. 5, the task scheduler optimizer 212 includes a model selection module 502, a configuring module 504, an input-pattern identification module 506, an execution module 508, and a monitoring module 510.

The model selection module 502 receives the plans and the associated efficiency scores from the task scheduler 210. Each plan indicates orders/schedules of the tasks and the foundation models identified for the tasks. Based on the efficiency scores of the plans, the model selection module 502 selects the foundation models for execution of the tasks. The model selection module 502 may compare the efficient scores of all the plans with each other and select a plan having the highest efficiency score among the other plans. The model selection module 502 may select one or more of foundation models from the set of foundation models identified for the selected plan. In some examples, the model selection module 502 may also select the foundation models based on the associated profiles. For example, the foundation models may be selected based on performance, cost, and/or the like. The selected foundation models may be used for execution of the tasks according to the corresponding plan. Further, the model selection module 502 generates the foundation model pipeline by including the selected foundation models for the tasks.

The configuring module 504 configures the selected foundation models. Configuring the foundation model may refer to selecting appropriate values for parameters of the foundation model, which aids in obtaining concise outputs from the foundation model. Examples of the parameters of the foundation model may include a number of nodes, an activation function, a learning rate, a batch size, an epoch, and/or the like of the foundation model.

In some examples, the configuring module 504 may configure the selected foundation models based on a cost associated with each of the foundation models. The cost may be determined based on historical benchmark data 512 of the foundation models.

For determining the cost associated with the foundation model, the configuring module 504 accesses the historical benchmark data 512 of the foundation models from the datastore 106 or an external source (not shown). From the historical benchmark data 512, the configuring module 504 may identify input sequences provided to the foundation model and output sequences received from the foundation model. Thereafter, the configuring module 504 may derive a number of tokens presented in the identified input sequences and output sequences of the foundation model. Based on the number of tokens presented in the identified input and output sequences of the foundation model, the configuring module 504 may determine the cost of the foundation model. Therefore, with such configuration, the cost of the task performed using the foundation model may be optimized/minimized by controlling lengths of the input and output sequences of the foundation model.

In some examples, if the cost of the foundation model dominates other preferences 410, the configuring module 504 may instruct the task planner 208 to estimate the utility factor of the foundation models and accordingly to update the plans generated for the tasks. The updated plans may be used for generating the completion plan. Therefore, the updated plans may be associated with the minimum cost.

The input-pattern identification module 506 identifies the input-patterns for regulating behavior of the selected foundation models. In some examples, the input-pattern identification module 506 may identify the input-patterns based on pre-defined input-patterns 514. The pre-defined input-patterns 514 may be accessed from the datastore 106. In some examples, the pre-defined input-patterns 514 may include maximum new tokens, temperature, and/or the like. In some examples, the pre-defined input-patterns 514 may also include specific instructions for regulating behavior of the foundation model. Examples of the specific instructions may include “think step by step”, “provide one sentence or 50 words summary” and/or the like, so that the output of the foundation model may be regulated.

Consider an example scenario, wherein the selected plan for execution of the tasks include: <task_1, foundation model_1>, <task_2, foundation model_2>, and <task_m, foundation model_m>. In such a scenario, an output of the foundation model_i may be used as an input to the foundation model_(i+1), wherein 1≤i≤(m−1). Therefore, the foundation models may be regulated to reduce a total length of their output sequences using the input patterns and the configuration.

In accordance with the generated foundation model pipeline, the configuration of the foundation models of the foundation model pipeline, and the identified input-patterns for the foundation models, the execution module 508 executes the tasks. Therefore, with such an execution, output of the tasks may be optimized.

Further, the monitoring module 510 monitors execution of the tasks. The monitoring module 510 may monitor an output of each of the tasks performed using the respectively selected foundation model and a quality of the output. If the output obtained from execution of any of the tasks using the respectively selected foundation model includes a very long output sequence, the model selection module 502 may dynamically reselect the foundation models for the execution of the remaining tasks. The foundation models may be reselected based on the associated cost.

Consider an example scenario, wherein a plan A is selected for execution of three tasks 1, 2, and 3 using foundation models A, B, and C, wherein the foundation models A and C are associated with low cost compared to the cost of the foundation model B. In such a scenario, the monitoring module 510 monitors that an output obtained from the execution of the task 1 using the foundation model A includes a very long output sequence. Instead of providing such a long output sequence to the next foundation model B (which is costly), the model selection module 502 selects the low-cost foundation model C for the task 2 based on the long output sequence of the foundation model A. An output of the foundation model C may be provided to the foundation model B for the task 3. Such a dynamic reselection of the foundation models aids in reducing the cost and increasing the quality of output of the tasks.

If the quality of the output obtained from execution of any of the tasks is low, the configuring module 504 may reconfigure the foundation models to execute/complete the remaining tasks of the plan. The foundation model may be reconfigured according to an output obtained from execution of the previous task of the plan. Consider an example scenario, wherein a plan A is selected for execution of three tasks 1, 2, and 3 using foundation models A, B, and C. In such a scenario, the monitoring module 510 monitors that an output obtained from the execution of the task 2 using the foundation model B is low. Based on the monitoring, the configuring module 504 reconfigures a next foundation model, for example, foundation model C for execution of the task 3.

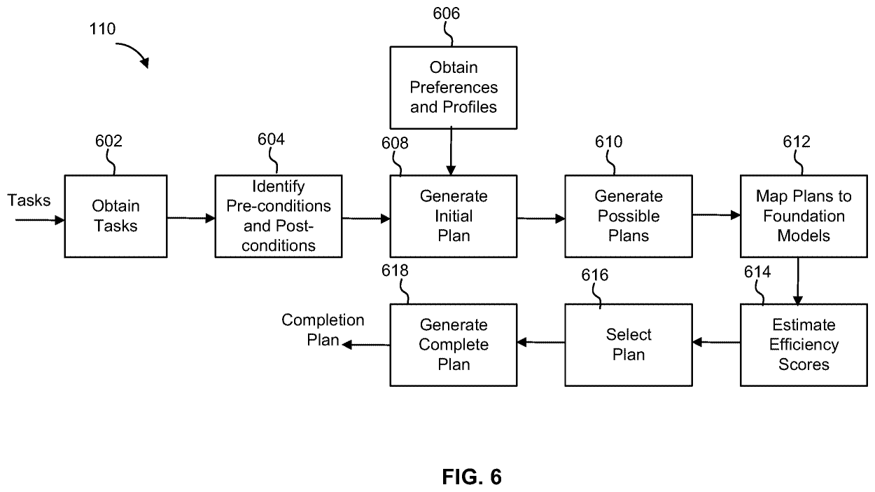

FIG. 6 depicts an example process flow of orchestration and scheduling of the tasks in accordance with implementations of the present disclosure. The multi-model task orchestrator system 110 receives the tasks and executes the tasks by efficiently planning the orders/schedules of the tasks using the foundation models and selecting an order from the planned orders to execute the tasks. The selected order for executing the tasks may be an efficient/optimized order adapting to the specific metrics prioritized by the preferences (provided by the user, for example, cost).

In an example, the multi-model task orchestrator system 110 obtains a task 1 and a task 2 602 to be performed/executed. The task 1 includes “translate a given article from German to English” and the task 2 includes “translate a given article from English to French”.

Upon receiving the tasks 1 and 2, the multi-model task orchestrator system 110 identifies pre-conditions and post-conditions 604 of the tasks 1 and 2. The pre-conditions and the post-conditions 604 may include:
Task 1: <Pre-condition: NULL; Post-Condition: Language=English>
Task 2: <Pre-condition: NULL; Post-Condition: Language=French>

The multi-model task orchestrator system 110 also obtains preferences for the tasks and profiles 606 of the foundation models. For example, the preferences may be user preferences indicating metrics to be satisfied for the tasks. The metrics may include cost, latency, and/or the like. The profiles indicate a number of foundation models available for the tasks, performance quality of the foundation models with respect to the tasks, and/or the like. From the profiles of the foundation models, the multi-model orchestrator system 110 identifies that foundation models A and B for the task 1 and foundation models A and C for the task 2, as depicted in an example table 2 below:

TABLE 2
Profiles of foundation models A, B, and C for tasks 1 and 2

| Foundation | | Performance |
|---|---|---|
| Model | Task Description | (BLEU) |
| Model A | German to English Translation | 0.4 |
| Model A | German to French Translation | 0.3 |
| Model B | German to English Translation | 0.35 |
| Model C | English to French Translation | 0.38 |

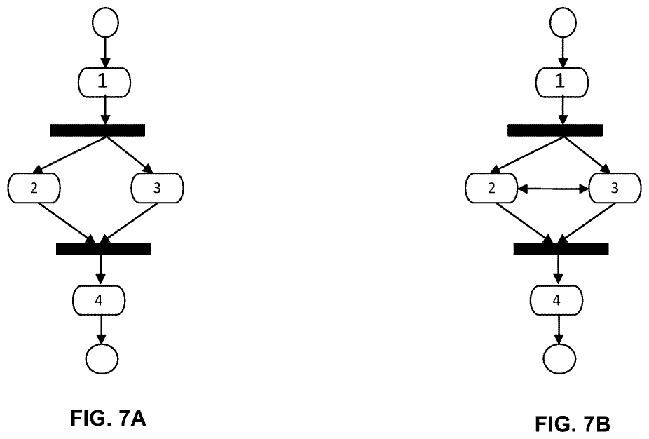

Based on the pre-conditions and the post-conditions 604 of the tasks and the profiles 606, the multi-model task orchestrator system 110 generates the set of possible plans 610 for the tasks 1 and 2. For generating the plans, the multi-model task orchestration system 110 generates an initial graph with an origin node and an end node. The origin node indicates <Object: Article A1, Language: German> and the end node indicates <<Object: Article A2, Language: English>, <Object: Article A3, Language: French>>. The multi-model task orchestrator system 110 updates the initial graph by generating an initial plan 608 for the tasks 1 and 2. The plan includes nodes 1, 2, 3, and 4. The nodes 1, 2, 3, and 4 are the origin node, the task 1, the task 2, and the end node (merge node 2 and node 3). As depicted in FIG. 7A, the initial plan includes: <<from node 1 to node 2>, <from node 1 to node 3>, <merge node 2 and 3>>.

Upon generating the initial plan, the multi-model task orchestrator system 110 generates an updated graph from the initial graph by generating all the plans 610 for the tasks 1 and 2. An example updated graph with all the plans 610 is depicted in FIG. 7B. The plans 610 of the updated graph include:
Plan 1: <<from node 1 to node 2>, <from node 1 to node 3>, <merge node 2 and 3>>
Plan 2: <<from node 1 to node 3>, <from node 1 to node 2>, <merge node 3 and 2>>
Plan 3: <<from node 1 to node 2>, <from node 2 to node 3>, <merge node 2 and 3>>
Plan 4: <<from node 1 to node 3>, <from node 3 to node 2>, <merge node 3 and 2>>

The multi-model task orchestrator system 110 maps the plans to the foundation models A, B, and C 612 based on the pre-conditions and post-conditions of the tasks and the profiles of the foundation models A, B, and C. For example, the mapping of the plans to the foundation models A, B, and C includes:
Plan 1A: <[<from node 1 to node 2>, foundation model A], [<from node 1 to node 3>, foundation model A], <merge node 2 and 3>>;
Plan 1B: <[<from node 1 to node 2>, foundation model B], [<from node 1 to node 3>, foundation model A], <merge node 2 and 3>>;
Plan 2A: <[<from node 1 to node 3>, foundation model A], [<from node 1 to node 2>, foundation model A], <merge node 3 and 2>>;
Plan 2B: <[<from node 1 to node 3>, foundation model A], [<from node 1 to node 2>, foundation model B], <merge node 3 and 2>>;
Plan 3A: <[<from node 1 to node 2>, foundation model A], [<from node 2 to node 3>, foundation model C], <merge node 2 and 3>>;
Plan 3B: <[<from node 1 to node 2>, foundation model B], [<from node 2 to node 3>, foundation model C], <merge node 2 and 3>>; and
Plan 4: Not feasible due to absence of any foundation models to perform <From Node 3 to Node 2> Task.

Once the plans are generated and mapped to the foundation models, the multi-model task orchestrator system 110 estimates the efficiency scores 614 of the plans. The efficiency score of the plan may be estimated based on the preferences specified for the foundation models in the plan, the profiles and number of foundation models present in the plan, the utility and incentive factors (described in detail in conjunction with FIG. 4) of the foundation models present in the plan. In an example herein, the incentive factor may be considered as 0.9. Exemplary utility factors of the foundation models with respect to the tasks is depicted in an example table 3 below:

TABLE 3
Profiles/utility factors of foundation
models A, B, and C for tasks 1 and 2

| Foundation | | | Utility |
|---|---|---|---|
| Model | Task Description | Performance | Factor |
| Model A | German to English Translation | 0.4 | 0.9 |
| Model A | German to French Translation | 0.3 | 0.6 |
| Model B | German to English Translation | 0.35 | 0.75 |
| Model C | English to French Translation | 0.38 | 0.85 |

Exemplary efficiency scores estimated for all the plans is depicted in an example table 4 below:

TABLE 4
Efficiency scores of plans

| Plans | Efficiency Score |
|---|---|
| Plan 1A | 0.675 |
| Plan 1B | 0.61 |
| Plan 2A | 0.675 |
| Plan 2B | 0.61 |
| Plan 3A | 0.75 |
| Plan 3B | 0.683 |

Once the efficiency scores 614 of the plans are generated, the multi-model task orchestrator system 110 selects the plan 616 with the highest efficiency score among the plans generated for the tasks. In this example, the multi-model task orchestrator system 110 selects the plan 3A for the tasks 1 and 2, as the plan 3A has the highest efficiency score (for example, 0.75) among the other plans.

The multi-model task orchestrator system 110 generates the completion plan 618 for the execution of the task based on the selected plan 616. The completion plan 618 may be generated by selecting or configuring one or more of the foundation models A and C present in the selected plan 616 for execution of the tasks. The one or more of the foundation models A and C present in the selected plan 616 may be selected or configured based on the cost of the foundation models A and C and the preferences (for example, cost specified by the user) for the tasks 1 and 2. Configuring the foundation models A and C may include varying values of the parameters of the foundation models A and C. In addition, the completion plan 618 may be generated by updating the pre-conditions and post-conditions of the tasks 1 and 2 (for example, by adding input patterns). Therefore, the behavior of the foundation models A and C may be regulated, while satisfying the preferences specified for the tasks 1 and 2.

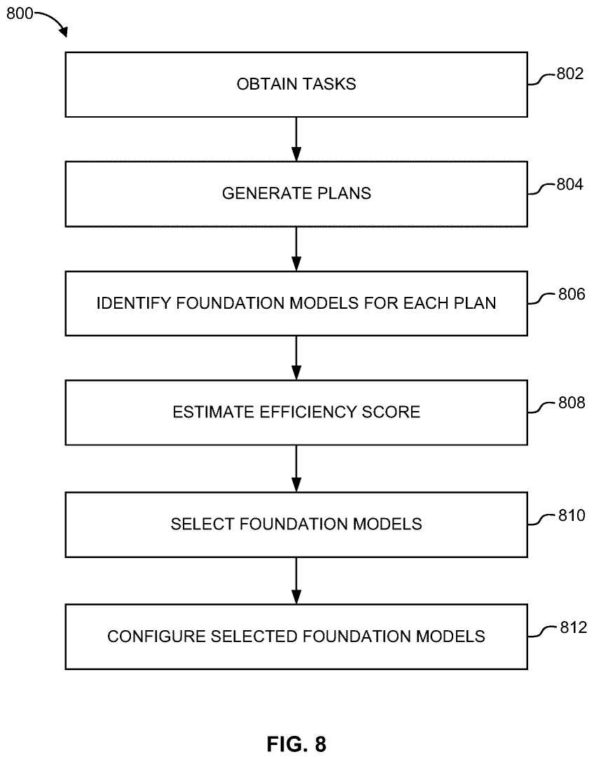

FIG. 8 is a flow diagram that presents an example method 800 for generating the foundation model pipeline for execution of the tasks in accordance with implementations of the present disclosure. In some implementations, the method 800 may be executed using components of the multi-model task orchestrator system 110 as described in relation to FIGS. 2-5.

At step 802, the method 800 includes obtaining the tasks. Each task has the set of pre-conditions and the set of post-conditions. Examples of the tasks may include conversation, conversation summarization, code generation, data processing, and/or the like. The pre-conditions may indicate a number of tokens to be present in input sequences, a type/format of the input sequences, and/or the like. The input sequences may refer to prompts provided to the foundation models 114a-114n for execution of the tasks. The post-conditions may indicate a number of tokens to be present in output sequences, a type/format of the output sequences, and/or the like, obtained from the foundation models 114a-114n in response to execution of the tasks.

At step 804, the method 800 includes generating the set of possible plans for processing the tasks. The set of possible plans are generated based on the set of pre-conditions and set of post-conditions of each task. Each of the possible plans may indicate orders/schedules for execution of the tasks. Generating the set of possible plans for the tasks is already described in detail in conjunction with FIGS. 2 and 3, therefore repeated description is omitted herein.

For each plan of the set of possible plans, at step 806, the method 800 includes identifying the set of foundation models from the foundation models 114a-114n. The set of foundation models are identified for performing the tasks according to the plan. The foundation model of the set of foundation models is identified based on the profile of the foundation model. The profile of the foundation model may indicate tasks for which the foundation model can be used and the performance/performance quality of the foundation model for the performed tasks.

Upon generating the set of possible plans for the tasks, at step 808, the method 800 includes estimating the efficiency score for each plan. The efficiency score of the plan is estimated based on the preferences, profiles, and number of foundation models identified for the plan, the utility factor, and the incentive factor. Estimating the efficiency score is already described in detail in conjunction with FIGS. 2 and 4, therefore repeated description is omitted herein.

At step 810, the method 800 includes selecting the set of foundation models. The set of foundation models are selected for the tasks based on the efficiency scores of the plans. The plan with the highest efficiency score among the set of possible plans is selected. The set of foundation models associated with the selected plan are selected for the tasks.

At step 812, the method 800 includes configuring the selected foundation models for the tasks. The foundation model is configured based on the cost associated the foundation model. The cost is determined based on a number of tokens input to the foundation model and number of tokens output by the foundation model. Further, the selected and configured set of foundation models are used for execution of the tasks. Therefore, the proposed method enables adaptation of the given tasks according to the profiles of the foundation models 114a-114n and the preferences specified for the tasks for optimizing the outputs of the tasks.

Implementations of the present disclosure provide technical solutions to multiple technical problems that arise in the context of applications interacting with multiple foundation models (in a multi-model GAI paradigm). Implementations of the present disclosure optimize selection of the foundation models for the tasks and resource usage through a dynamic, cost-effective approach, ensuring resilience and flexibility in an ever-evolving AI landscape.

Implementations of the present disclosure also provide flexibility in integration of foundation models into the enterprise systems for efficiently executing customized tasks with minimal technical guidance. Further, with such an integration, the execution of the tasks provides consistent outputs/results that align with expected outcomes, reducing unexpected interactions with users. Implementations of the present disclosure also provide for efficiencies in terms of technical resource consumption, which also includes minimizing latency (even under heavy loads). For example, implementations of the present disclosure optimize use of technical resources (processors, memory, bandwidth) with respect to the tasks to achieve, for example, cost reduction (e.g., in terms of technical resources expended) and/or improvements in UX (e.g., reduced latency). Implementations of the present disclosure also enable tailored control enabling bespoke customization and fine-tuning behavior of the foundation models to specific needs and preferences.

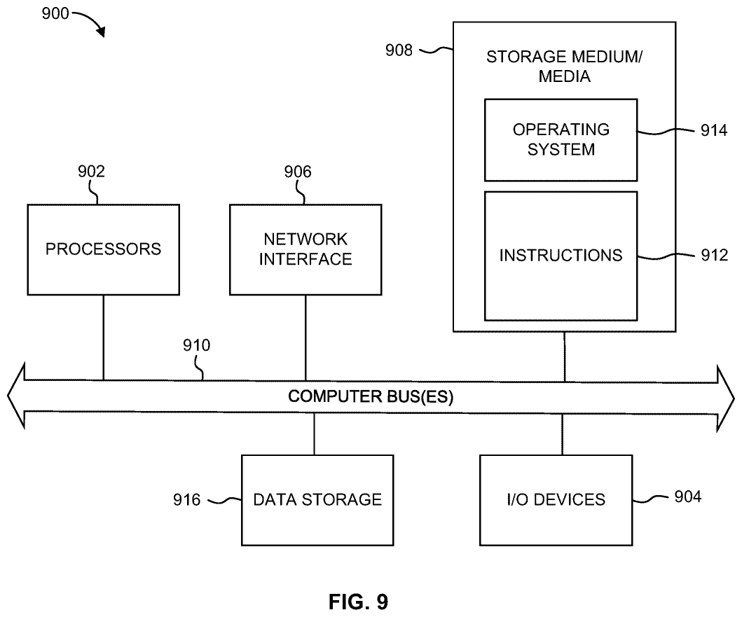

FIG. 9 illustrates a computer system 900 that may be used to implement the computer-implemented method 800 for managing the tasks by generating the foundation model pipeline. The More particularly, computing machines such as desktops, laptops, smartphones, tablets, and wearables, which may be used for task management by generating the foundation model pipeline and that may have the structure of the computer system 900/multi-model task orchestrator system 110. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 802.11x LAN, a 3G or 4G mobile WAN or a WiMax WAN, and a computer-readable medium 908. Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the computer-implemented method 800 and functions of the multi-model task orchestration system 110.

The components of the multi-model task orchestration system 110 (such as the task planner 208, the task scheduler 210, and the task scheduler optimizer 212) may be implemented as software stored on a non-transitory processor-readable medium and executed by the processors 902. For example, the computer-readable medium 908 may store an operating system 914, such as MAC OS, MS WINDOWS, UNIX, or LINUX, and code for the multi-model task orchestration system 110. The operating system 914 may be multi-user, multiprocessing, multitasking, multithreading, real-time, and the like. For example, during runtime, the operating system 914 is running and the code for the multi-model task orchestration system 110 is executed by the processor(s) 902.

The computer system 900 may include a data storage 916, which may include non-volatile data storage. The data storage 916 stores any data used or generated by the multi-model task orchestration system 110.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (for example, one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for generating a foundation model pipeline, the method being executed by one or more processors and comprising:
obtaining a plurality of tasks, wherein each task, of the plurality of tasks, has a set of pre-conditions and a set of post-conditions;
generating a set of possible plans for processing the plurality of tasks based on the set of pre-conditions and set of post-conditions of each task, of the plurality of tasks;
identifying, for each plan of the set of possible plans, a set of foundation models, from a plurality of foundation models, for performing each task of the plurality of tasks according to each plan;
estimating an efficiency score for each plan to perform the plurality of tasks according to each plan; and
selecting the set of foundation models for the plurality of tasks based on the estimated efficiency score of each plan.

2. The method of claim 1, wherein the efficiency score is estimated based on at least one of:
preferences for the set of foundation models in each plan,
profiles for the set of foundation models in each plan; and
a number of foundation models in each plan.

3. The method of claim 1, wherein a plan is generated by matching the set of post-conditions for a first task to the set of pre-conditions for a second task.

4. The method of claim 1, wherein a foundation model, of the set of foundation models, is identified based on a foundation model profile indicating tasks performed by the foundation model and a performance of the foundation model for the tasks performed by the foundation model.

5. The method of claim 1, further comprising configuring a foundation model, of the selected set of foundation models based on a cost associated with the foundation model.

6. The method of claim 5, further comprising reconfiguring a next foundation model, of the selected set of foundation models, after each task of a plan according to an output of a previous task of the plan.

7. An apparatus for generating a foundation model pipeline, comprising:
at least one memory; and
at least one processor coupled to the at least one memory and configured to:
obtain a plurality of tasks, wherein each task, of the plurality of tasks, has a set of pre-conditions and a set of post-conditions;
generate a set of possible plans for processing the plurality of tasks based on the set of pre-conditions and set of post-conditions of each task, of the plurality of tasks;
identify, for each plan of the set of possible plans, a set of foundation models, from a plurality of foundation models, for performing each task of the plurality of tasks according to each plan;
estimate an efficiency score for each plan to perform the plurality of tasks according to each plan; and
select the set of foundation models for the tasks based on the estimated efficiency score of each plan.

8. The apparatus of claim 7, wherein the efficiency score is estimated based on at least one of:
preferences for the foundation models in each plan,
profiles for the foundation models in each plan; and
a number of foundation models in each plan.

9. The apparatus of claim 7, wherein a plan is generated by matching the set of post-conditions for a first task to the set of pre-conditions for a second task.

10. The apparatus of claim 7, wherein a foundation model, of the set of foundation models, is identified based on a foundation model profile indicating tasks performed by the foundation model and a performance of the foundation model for the tasks performed by the foundation model.

11. The apparatus of claim 7, wherein the at least one processor is further configured to configure a foundation model, of the selected set of foundation models based on a cost associated with the foundation model.

12. The apparatus of claim 11, wherein the at least one processor is further configured to reconfigure a next foundation model, of the selected set of foundation models, after each task of a plan according to an output of a previous task of the plan.

13. A non-transitory computer-readable medium having stored thereon instructions that, when executed by at least one processor, cause the at least one processor to:
obtain a plurality of tasks, wherein each task, of the plurality of tasks, has a set of pre-conditions and a set of post-conditions;
generate a set of possible plans for processing the plurality of tasks based on the set of pre-conditions and set of post-conditions of each task, of the plurality of tasks;
identify, for each plan of the set of possible plans, a set of foundation models, from a plurality of foundation models, for performing each task of the plurality of tasks according to each plan;
estimate an efficiency score for each plan to perform the plurality of tasks according to each plan; and
select the set of foundation models for the plurality of tasks based on the estimated efficiency score of each plan.

14. The non-transitory computer-readable medium of claim 13, wherein the efficiency score is estimated based on at least one of:
preferences for the foundation models in each plan,
profiles for the foundation models in each plan; and
a number of foundation models in each plan.

15. The non-transitory computer-readable medium of claim 13, wherein a plan is generated by matching the set of post-conditions for a first task to the set of pre-conditions for a second task.

16. The non-transitory computer-readable medium of claim 13, wherein a foundation model, of the set of foundation models, is identified based on a foundation model profile indicating tasks performed by the foundation model and a performance of the foundation model for the tasks performed by the foundation model.

17. The non-transitory computer-readable medium of claim 13, wherein the instructions further cause the at least one processor to configure a foundation model, of the selected set of foundation models based on a cost associated with the foundation model.

18. The non-transitory computer-readable medium of claim 17, wherein the instructions further cause the at least one processor to reconfigure a next foundation model, of the selected set of foundation models, after each task of a plan according to an output of a previous task of the plan.
